(19) United States
(12) Patent Application Publication
(10) Pub. No.: US 2021/0302178 A1
(43) Pub. Date: Sep. 30, 2021

(54) OPERATION MANAGEMENT APPARATUS, OPERATION MANAGEMENT SYSTEM, OPERATION MANAGEMENT METHOD, AND VEHICLE

(71) Applicant: TOYOTA JIDOSHA KABUSHIKI KAISHA, Toyota-shi (JP)

(72) Inventors: Yuki TATSUMOTO, Nagoya-shi (JP); Saori MATSUMOTO, Chofu-shi (JP); Keigo YAMADA, Toyota-shi (JP); Akira SASAKI, Miyoshi-shi (JP); Mitsuhiro MIURA, Toyota-shi (JP)

(73) Assignee: TOYOTA JIDOSHA KABUSHIKI KAISHA, Toyota-shi (JP)

(21) Appl. No.: 17/201,699

(22) Filed: Mar. 15, 2021

(30) Foreign Application Priority Data
Mar. 30, 2020 (JP) 2020-061372

(51) Int. Cl. G01C 21/34; G01C 21/36

(52) U.S. Cl. CPC G01C 21/3438; G01C 21/3605; G01C 21/3461; G01C 21/3492; G01C 21/3484

(57) ABSTRACT

An operation management apparatus includes a controller configured to manage operation of a vehicle. The controller is configured to: cause the vehicle to provide a first service for transporting a user between at least two points during a first time period; and cause the vehicle to provide a second service for enabling the user to stay at a predetermined point or in a predetermined area during a second time period.

### CROSS-REFERENCE TO RELATED APPLICATION

This application claims priority to Japanese Patent Application No. 2020-061372 (filed on Mar. 30, 2020), the entire contents of which are incorporated herein by reference.

### TECHNICAL FIELD

The present disclosure relates to an operation management apparatus, an operation management system, an operation management method, and a vehicle.

### BACKGROUND

Vehicles which operate in accordance with demand from users are known. For example, Patent Literature (PTL) 1 discloses an operation management method for improving operation efficiency.

### CITATION LIST

### Patent Literature

PTL 1: JP 2019-016290A

### SUMMARY

The operation efficiency of vehicles for transporting users decreases when the number of users who demand to travel decreases. There is a need to improve the operation efficiency of the vehicles.

It would be helpful to improve the operation efficiency of vehicles.

An operation management apparatus according to an embodiment of the present disclosure includes

a controller configured to manage operation of a vehicle, wherein

the controller is configured to:

cause the vehicle to provide a first service for transporting a user between at least two points during a first time period; and

cause the vehicle to provide a second service for enabling the user to stay at a predetermined point or in a predetermined area during a second time period.

An operation management system according to an embodiment of the present disclosure includes:

the operation management apparatus; and

the vehicle.

An operation management method for managing operation of a vehicle according to an embodiment of the present disclosure includes:

causing the vehicle to provide a first service for transporting a user between at least two points during a first time period; and

causing the vehicle to provide a second service for enabling the user to stay at a predetermined point or in a predetermined area during a second time period.

A vehicle according to an embodiment of the present disclosure is configured to:

provide a first service for transporting a user between at least two points during a first time period; and

provide a second service for enabling the user to stay at a predetermined point or in a predetermined area during a second time period.

According to the operation management apparatus, the operation management system, the operation management method, and the vehicle according to the embodiments of the present disclosure, the operation efficiency of the vehicles can be improved.

### BRIEF DESCRIPTION OF THE DRAWINGS

In the accompanying drawings:

FIG. 1 is a schematic diagram illustrating an example configuration of an operation management system according to an embodiment;

FIG. 2 is a block diagram illustrating an example configuration of the operation management system according to the embodiment; and

FIG. 3 is a flowchart illustrating an example of a procedure of an operation management method according to the embodiment.

### DETAILED DESCRIPTION

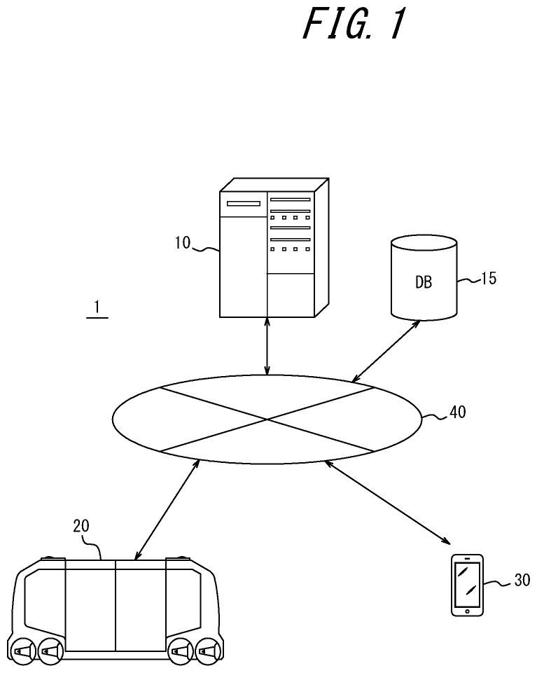

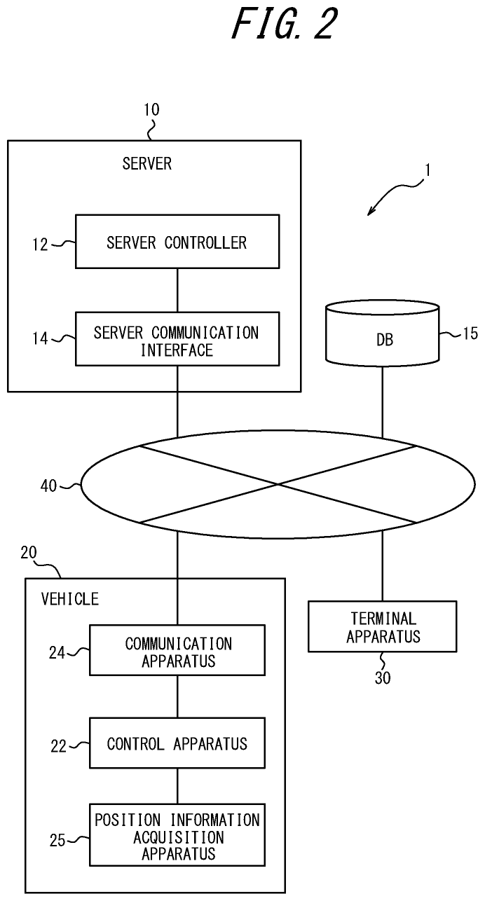

As illustrated in FIGS. 1 and 2, an operation management system 1 according to an embodiment includes a server 10, a vehicle 20, and a terminal apparatus 30. The operation management system 1 further includes a database (DB) 15, although this is not required. The server 10, the vehicle 20, the terminal apparatus 30, and the DB 15 are connected to a network 40 and are communicable with each other. Each of the server 10, the vehicle 20, the terminal apparatus 30, and the DB 15 is not limited to one and may be two or more in number.

The operation management system 1 provides a first service for boarding a user to the vehicle 20 and travelling between at least two points so as to transport the user. The first service is also referred to as an on-demand bus service.

The operation management system 1 provides a second service for providing the user with a stay space in the vehicle 20. The vehicle 20 may provide the second service while remaining at a predetermined point. The vehicle 20 may provide the second service while travelling within a predetermined area and stopping as needed. That is, the vehicle 20 provides the second service at the predetermined point or in the predetermined area. When providing the second service while travelling, the vehicle 20 travels regardless of a boarding point and an alighting point designated by the user, or without accepting the designation. That is, the vehicle 20, although providing the second service while traveling along a predefined route within the predetermined area, does not transport the user. The second service is also referred to as a stay service.

The operation management system 1 manages the operation of the vehicle 20 in accordance with each of the case in which the vehicle 20 provides the first service and the case in which the vehicle 20 provides the second service.

The user is in possession of the terminal apparatus 30 and may apply for use of the first service or the second service provided by the vehicle 20 by accessing the server 10 through the terminal apparatus 30.

The server 10 may accept an application from the user for use of the first service or the second service and determine an operation route or an operation schedule for the vehicle 20 based on the application. The server 10 may determine whether the application from the user for use of the first service or the second service is acceptable based on an operation status of the vehicle 20. The server 10 may determine the operation route or the operation schedule for the vehicle 20 based on the status of the application from the user. The server 10 is also referred to as an operation management apparatus.

The first service and the second service may be provided by the same entity or may be provided by different entities. The operation management system 1 that manages the operation of the vehicle 20 may be operated by the entity providing the first service, by the entity providing the second service, or by another different entity.

The server 10 may include a single server apparatus, or a plurality of server apparatuses capable of communicating with each other. The server 10 manages the application for use of the first service or the second service that has been accepted from the user. The server 10 may transmit and receive various types of information related to the provision of the first service or the second service to and from the vehicle 20. The server 10 may be configured to execute, in addition to the above processing, various types of processing related to the provision of the first service or the second service. The server 10 manages the operation of the vehicle 20. The server 10 may communicate with the vehicle 20 to thereby acquire various types of information related to the vehicle 20, such as a position or a speed of the vehicle 20. The server 10 may be configured to execute, in addition to the above processing, various types of processing to manage the operation of the vehicle 20.

The server 10 includes a server controller 12 and a server communication interface 14. The server controller 12 may include at least one processor. The server controller 12 is also referred to simply as a controller. The “processor” in the present embodiment may be, but is not limited to, a general-purpose processor, or a dedicated processor that is dedicated to specific processing. The server controller 12 may include at least one dedicated circuit. The dedicated circuit may include, for example, a Field-Programmable Gate Array (FPGA) and an Application Specific Integrated Circuit (ASIC). The server controller 12 may include the dedicated circuit instead of the processor, or may include the dedicated circuit along with the processor. The server communication interface 14 includes a communication module and may communicate with the vehicle 20. The server 10 may further include a memory. The memory may be, but is not limited to, a semiconductor memory, a magnetic memory, or an optical memory. The memory may function as, for example, a main memory, an auxiliary memory, or a cache memory. The memory may include an electromagnetic storage medium, such as a magnetic disc. The memory may include a non-transitory computer readable medium. The memory may store any information used for the operations of the server 10. For example, the memory may store a system program, an application program, or the like. The server 10 may store a program, information, or the like, using the DB 15 as the memory.

The vehicle 20 may be configured to be used for both the provision of the first service and the provision of the second service. The vehicle 20 includes a first specification including a seat or the like for providing the first service to the user, and a second specification including the stay space for providing the second service to the user. The vehicle 20 may include both the first specification and the second specification. The vehicle 20 may be configured to be changeable between the first specification and the second specification. The vehicle 20 is not limited to one and may be two or more in number.

The vehicle 20 may be configured to operate using automated driving. The automated driving may be, for example, performed at any level from Level 1 to Level 5 as defined by the Society of Automotive Engineers (SAE). The automated driving may be performed based on other definitions without being limited to the exemplified definition.

The vehicle 20 includes a control apparatus 22 and a communication apparatus 24. The control apparatus 22 and the communication apparatus 24 are communicably connected to each other, for example, via an in-vehicle network, such as a Controller Area Network (CAN), or a dedicated line.

The control apparatus 22 controls individual components included in the vehicle 20. The control apparatus 22 may include at least one processor. The control apparatus 22 may include at least one dedicated circuit instead of the processor, or may include at least one dedicated circuit along with the processor. The control apparatus 22 may further include a memory.

The communication apparatus 24 communicates with the server 10 via the network 40. The communication apparatus 24 may communicate with the terminal apparatus 30 via the network 40, or may communicate with the terminal apparatus 30 without using the network 40. The communication apparatus 24 may be, for example, an in-vehicle communication device. The communication apparatus 24 may include a communication module for connection with the network 40. The communication module may include, but is not limited to, a communication module conforming to mobile communication standards, such as the 4^{th} Generation (4G) standard or the 5^{th} Generation (5G) standard.

The vehicle 20 further includes a position information acquisition apparatus 25, although this is not required. The position information acquisition apparatus 25 and other components mounted in the vehicle 20 are connected so as to communicate with each other, via the in-vehicle network such as the CAN, or the dedicated line. The position information acquisition apparatus 25 acquires position information of the vehicle 20. The position information acquisition apparatus 25 may include a receiver compatible with a satellite positioning system. The receiver compatible with the satellite positioning system may include, for example, a Global Positioning System (GPS) receiver. In the present embodiment, the vehicle 20 is assumed to be capable of acquiring the position information of the vehicle 20 itself by using the position information acquisition apparatus 25. The vehicle 20 may output the vehicle 20's own position information to the server 10 or the terminal apparatus 30.

The terminal apparatus 30 may communicate with the vehicle 20 via the network 40 or without using the network 40. The terminal apparatus 30 communicates with the server 10 via the network 40. The terminal apparatus 30 may include, for example, a mobile terminal such as a smartphone.

The terminal apparatus 30 may run an application that is used by the user to apply for use of the first service or the second service. The terminal apparatus 30 may communicate with the server 10 to transmit and receive information related to the application for use of the service. When the user uses the service in the vehicle 20, the terminal apparatus 30 may communicate with the vehicle 20 and transmit and receive information for authenticating whether the vehicle 20 is the vehicle 20 allocated to the application for use from the user.

The terminal apparatus 30 may include a configuration that, for example, is identical or similar to that of the position information acquisition apparatus 25 included in the vehicle 20 to thereby acquire the position information of the terminal apparatus 30 itself. The terminal apparatus 30 may output the terminal apparatus 30′s own position information to the server 10 or the vehicle 20.

(Operation Example of Operation Management System 1)

<Application for Use of Service>

The terminal apparatus 30 accepts an input from the user applying for use of the service. When the user applies for use of the first service or the second service, the terminal apparatus 30 generates, based on the input from the user, the service application information to be transmitted to the server 10. The service application information includes information for identifying whether the user applies for use of the first service or applies for use of the second service.

When the user applies for use of the first service, the service application information includes a point or an area at which the user wants to board the vehicle 20 and a point or an area at which the user wants to alight from the vehicle 20. The point or the area at which the user wants to board the vehicle 20 is also referred to as a desired point of origin. The point or the area in which the user wants to alight from the vehicle 20 is also referred to as a desired destination. The first service application information may further include a time or a time of day at which the user wants to board the vehicle 20, or a time or a time of day at which the user wants to alight from the vehicle 20. The time or the time of day at which the user wants to board the vehicle 20 is also referred to as a desired departure time. The time or the time of day at which the user wants to alight from the vehicle 20 is also referred to as a desired arrival time. A condition that the user wants the vehicle 20 that he or she is to board to preferably satisfy is also referred to as a desired condition.

When the user applies for use of the second service, the service application information includes the type of service that the user wants to use. The type of the service may include, for example, the provision of a product or a service at a mobile shop, the provision of the stay space, or the like. The vehicle 20 may prompt the user to use the second service being provided, regardless of whether the user has applied for use of the second service. The service application information may include a time of day at which the user wants to use the second service. The service application information may include a point or an area at which the user wants to use the second service.

<Management of Operation of Vehicle 20>

The server controller 12 of the server 10 manages the operation of the vehicle 20 based on the service application information received from the terminal apparatus 30. The server controller 12 may manage the operation of a plurality of the vehicles 20.

«Categorization of Vehicle 20»

A vehicle 20 may be configured to provide only one of the first service and the second service at all times. A vehicle 20 that is configured to provide only one of the first service and the second service at all times is also referred to as a dedicated vehicle. A dedicated vehicle configured to provide only the first service is also referred to as a first dedicated vehicle. A dedicated vehicle configured to provide only the second service is also referred to as a second dedicated vehicle.

A vehicle 20 may include a vehicle 20 configured to provide either the first service or the second service. A vehicle 20 that is configured to provide either the first service or the second service is also referred to as a common vehicle. The server controller 12 designates a common vehicle as either a vehicle 20 that provides the first service or a vehicle 20 that provides the second service. A first dedicated vehicle and a common vehicle designated to provide the first service are both referred to as first vehicles. A second dedicated vehicle and a common vehicle designated to provide the second service are both referred to as second vehicles.

«Designation of First Vehicle and Second Vehicle»

The server controller 12 may determine a required number of first vehicles based on the number of users applying for use of the first service. The server controller 12 designates as many common vehicles as the number corresponding to a difference between the required number of first vehicles and the number of first dedicated vehicles as first vehicles. Accordingly, the required number of first vehicles is met.

The server controller 12 may determine the required number of first vehicles to provide the first service at a certain time of the day based on the number of users applying for use of the first service at that certain time of day. The server controller 12 may determine the required number of first vehicles further based on the desired conditions of the users.

When a single common vehicle is looked at, the server controller 12 may designate the common vehicle as either a first vehicle or a second vehicle based on the required number of first vehicles. For example, the server controller 12 may designate the single common vehicle as a first vehicle, conditional on the difference between the required number of first vehicles and the number of first dedicated vehicles being greater than or equal to a predetermined number. The server controller 12 may vary the predetermined number to be set for each common vehicle as the condition for designating the common vehicle as a first vehicle. For example, when the operation management system 1 manages X common vehicles, the server controller 12 may set, for each common vehicle, any number from 1 to X as the predetermined number. In this way, as many common vehicles as the number corresponding to the difference between the required number of first vehicles and the number of first dedicated vehicles are designated as first vehicles. Thus, the required number of first vehicles is met.

The server controller 12 may designate a common vehicle as a second vehicle when the difference between the required number of first vehicles and the number of first dedicated vehicles is less than the predetermined number.

As described above, a common vehicle can be designated as a first vehicle or can be designated as a second vehicle. The time period in which a common vehicle is designated as a first vehicle is also referred to as a first time period. The time period in which a common vehicle is designated as a second vehicle is also referred to as a second time period. It can be said that the server controller 12 designates a common vehicle as either a first vehicle or a second vehicle by setting the first time period and the second time period.

The server controller 12 may set the first time period to a time of day at which an increased number of users apply for use of the first service. The server controller 12 may, for example, set the first time period to a time of day when an increased number of users commute to work or school, such as a weekday morning or a weekday evening. The server controller 12 may set the second time period to a time of day at which a decreased number of users apply for use of the first service. The server controller 12 may, for example, set the second time period to a time of day excluding the time of day for commuting to work or school, such as a weekday afternoon, or early morning or late at night. Further, the server controller 12 may set the second time period to a holiday, for example.

«Change of Specification of Common Vehicle»

A common vehicle may be changed to the first specification when being designated as a first vehicle and may be changed to the second specification when being designated as a second vehicle. For example, a common vehicle may include a stowable seat, and, when designated as a first vehicle, may be changed to the first specification in which the seat is deployed so as to allow the user to sit and, when designated as a second vehicle, may be changed to the second specification in which the seat is stowed so as to make a space. A common vehicle may include a means for deploying or stowing the seat. In this case, the change between the first specification and the second specification occurs automatically. The seat may be manually deployed or stowed. In this case, the change between the first specification and the second specification occurs manually.

In the second specification, a common vehicle includes a space for providing the second service to the user. When the stowable seat is included, a common vehicle makes the space for providing the second service by stowing the seat.

A common vehicle may include, in part of the space, equipment used to provide the second service. The equipment is configured to be detachable from the common vehicle, and may be mounted in the common vehicle when the common vehicle is changed to the second specification and may be detached when the common vehicle is changed to the first specification.

The equipment may include, for example, a shelf on which foods and beverages, everyday items, or the like are displayed for selling in the mobile shop, a point of contact for serving the user, etc. The equipment may include, for example, a table or the like used by the user. The equipment may include, for example, a booth that the user can use as the stay space.

In a case in which the equipment is mounted or detached in or from a common vehicle during the change between the first specification and the second specification, a common vehicle may travel to a predetermined facility to mount or detach the equipment. The predetermined facility may be a warehouse or the like for storing the equipment detached from a common vehicle.

«Management of Operation of First Vehicle»

The server controller 12 manages one or more first vehicles. The server controller 12 determines the operation route or the operation schedule for each first vehicle based on the desired conditions of one or more users.

When receiving information that the user applies for use of the first service as the service application information, the server controller 12 extracts a first vehicle that meets the desired condition of the user. If no first vehicle meets the desired condition of the user, the server controller 12 may extract a first vehicle that, in part, does not meet the desired condition of the user. In the case in which no first vehicle meets the desired condition of the user, the server controller 12 may transmit, to the terminal apparatus 30, information proposing that the user change the desired condition. The terminal apparatus 30 accepts an input as to whether the user accepts the change in the desired condition. When the user accepts the change in the desired condition, the terminal apparatus 30 also accepts an input as to the condition to be changed. The terminal apparatus 30 transmits, to the server 10, the information inputted by the user. When the user has changed the desired condition, the server 10 extracts a first vehicle that meets the desired condition after the change.

The server controller 12 transmits, to the terminal apparatus 30, information regarding the extracted first vehicle. The terminal apparatus 30 notifies the user of the information regarding the extracted first vehicle, accepts an input as to whether the user accepts or rejects boarding of that first vehicle, and transmits a result of the input to the server 10. When the user has accepted boarding of the extracted first vehicle, the server 10 determines that the user is to board that first vehicle. The determined first vehicle that the user is to board is also referred to as a boarding vehicle. When the user rejects boarding of the extracted first vehicle, the server 10 extracts a different first vehicle and transmits this information to the terminal apparatus 30. The server controller 12 may determine that the extracted first vehicle is to be the boarding vehicle as it is.

The server controller 12 determines the operation schedule so that the user can board the determined boarding vehicle. The server controller 12 transmits, to the boarding vehicle, a control instruction including the operation schedule. The server controller 12 transmits, to the terminal apparatus 30 of the user, information regarding the boarding point and the boarding time as determined based on the operation schedule.

«Management of Operation of Second Vehicle»

The server controller 12 manages one or more second vehicles. When receiving information that the user applies for use of the second service as the service application information, the server controller 12 may prepare a second vehicle that provides the second service of a type that the user wants to use. The server controller 12 may prepare a second vehicle that provides a predetermined type of the second service regardless of the service application information. The server controller 12 may determine the type of service to be provided by the second vehicle based on record data for past usage of the second service. The server controller 12 may determine the type of service to be provided by the second vehicle based on a time of day included in the second time period.

The server controller 12 determines a point or an area at which the second service is to be provided. In a case in which information indicating the point or the area at which the user wants to use the second service is included in the service application information, the server controller 12 may determine the point or the area at which the second service is to be provided based on that information. The server controller 12 may determine the point or the area at which the second service is to be provided regardless of the service application information. The server controller 12 may determine the point or the area at which the second service is to be provided based on the record data for past usage of the second service. The server controller 12 may determine the point or the area at which the second service is to be provided based on the time of day included in the second time period.

The server controller 12 transmits, to the second vehicle, the control instruction including the determined type of service to be provided by the second vehicle. Based on the control instruction, the second vehicle changes the specification so as to provide the determined type of service. The server controller 12 may transmit, to the second vehicle, the control instruction including the point or the area at which the second service is to be provided. Based on the control instruction, the second vehicle travels to the point or the area at which the second service is to be provided. In a case in which the second service is to be provided in a predetermined area, the second vehicle may provide the second service while remaining at any point within the predetermined area, or may provide the second service while travelling within the predetermined area as needed. The server controller 12 may transmit the type of service to be provided as the second service to the terminal apparatus 30 of the user so as to notify the user and prompt the user to use the second service. The server controller 12 may transmit, to the terminal apparatus 30 of the user, the point or the area at which the second service is to be provided for notification to the user.

<Summary>

As has been described, the operation management system 1 according to the present embodiment includes a common vehicle capable of operating as a first vehicle that provides the first service and also capable of operating as a second vehicle that provides the second service. The operation management system 1 operates a common vehicle as a first vehicle in the first time period and as a second vehicle in the second time period. By doing so, when one of the number of users using the first service and the number of users using the second service decreases, the operation management system 1 reduces the number of unused vehicles 20 that are unable to provide a service. Consequently, the operation efficiency of the vehicles 20 is improved.

(Example of Flowchart Illustrating Operation Management Method)

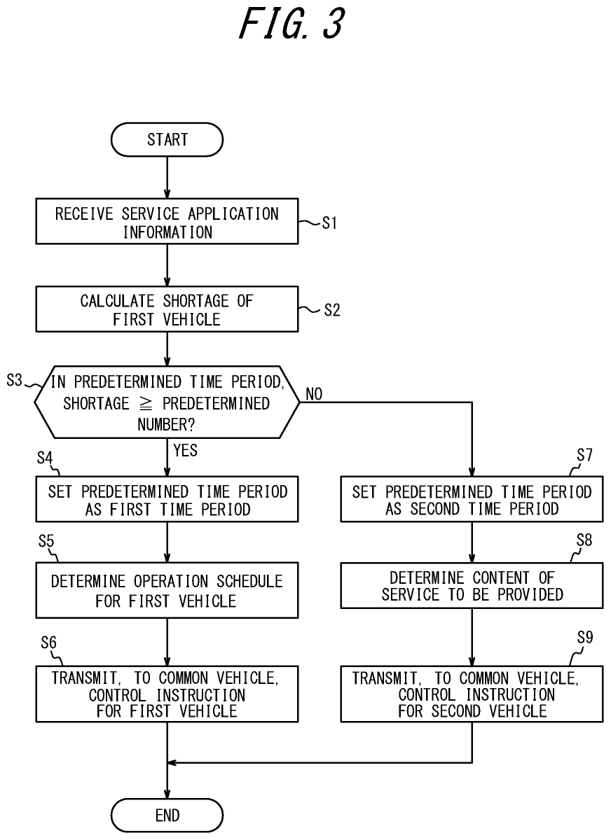

The server controller 12 of the server 10 included in the operation management system 1 may execute an operation management method including a procedure of the flowchart illustrated in FIG. 3. The operation management method may be implemented as an operation management program to be executed by a processor, such as the server controller 12. The operation management program may be stored on a non-transitory computer readable medium.

The server controller 12 receives the service application information from the terminal apparatus 30 (Step S1).

The server controller 12 calculates a shortage of first vehicles based on the service application information (Step S2). The shortage of first vehicles is calculated as the difference between the required number of first vehicles and the number of first dedicated vehicles.

The server controller 12 judges whether the condition that the shortage of first vehicles is greater than or equal to the predetermined number is met in a predetermined period (Step S3).

When the condition that the shortage of first vehicles is greater than or equal to the predetermined number is met in the predetermined period (Step S3: YES), the server controller 12 sets the predetermined period as the first time period (Step S4). The server controller 12 determines the operation schedule for operating a common vehicle as a first vehicle in the first time period (Step S5). The server controller 12 transmits, to a common vehicle, the control instruction for a first vehicle (Step S6). The server controller 12 generates the control instruction including the operation schedule to be transmitted to a common vehicle. After performing the procedure of Step S6, the server controller 12 ends the execution of the flowchart of FIG. 3.

When the condition that the shortage of first vehicles is greater than or equal to the predetermined number is not met in the predetermined period (Step S3: NO), that is, when the shortage of first vehicles is less than the predetermined number in the predetermined period, the server controller 12 sets the predetermined period as the second time period (Step S7). The server controller 12 determines the content of service to be provided by a common vehicle in the second time period (Step S8). The server controller 12 may determine the type of service as the content of the service. The server controller 12 may determine an area at which the service is to be provided as the content of the service. The server controller 12 may determine a time of day at which the service is to be provided as the content of the service. The server controller 12 transmits, to a common vehicle, the control instruction for a second vehicle (Step S9). The server controller 12 may transmit the content of the service to be provided as the second service to the terminal apparatus 30 so as to notify the user and prompt the user to use the service. After executing the procedure of Step S9, the server controller 12 ends the execution of the flowchart of FIG. 3.

After setting the time period in which the shortage of first vehicles is greater than or equal to the predetermined number as the first time period, the server controller 12 may execute the procedures of Step S5 and Step S6 and manage a common vehicle in the first time period. After setting the time period in which the shortage of first vehicles is less than the predetermined number as the second time period, the server controller 12 may execute the procedures of Step S8 and Step S9 and manage a common vehicle in the second time period.

As has been described, according to the operation management method or the operation management program according to the present embodiment, a common vehicle can be operated as a first vehicle that provides the first service or can be operated as a second vehicle that provides the second service. Thus, when one of the number of users using the first service and the number of users using the second service decreases, the number of unused vehicles 20 that are unable to provide a service is reduced. Consequently, the operation efficiency of the vehicles 20 is improved.

(Other Embodiments)

<Types of Second Service>

In the operation management system 1 according to the present embodiment, for example, the following services can be provided as the second service.

The second service may include the selling of a product or the provision of a service by enabling the user to stay in a mobile shop. For example, the mobile shop may include a shop that sells fresh food, such as fruits and vegetables, meat, or fresh fish, processed food, beverages, etc. The mobile shop may include a shop that sells books, everyday items, etc. The mobile shop may include the point of contact for an office, a bank, or the like. The mobile shop may include a restaurant, such as a cafe or a pub, that provides food and beverages.

The mobile shop may include a mobile nursery that takes care of infants, etc. A second vehicle that provides the mobile nursery service may have a nursery teacher, a babysitter, or the like on board.

The mobile shop may include a dog cafe that offers interaction with dogs, a cat cafe that offers interaction with cats, or the like. The mobile shop may include a pet shop in which various pets, such as dogs or cats, are displayed or taken care of. A second vehicle that provides the animal-related service may have a veterinarian or the like on board.

The mobile shop is not limited to the above examples and may include various forms of shops. When being used as the mobile shop, the vehicle 20 may include various types of equipment constituting the mobile shop that is configured to be detachable.

The second service may include the provision of the stay space in which the user can stay. For example, the stay space may include a smoking room. The stay space may include a space including a set of tables for eating or drinking. The stay space may include a powder room (restroom). The stay space may include a bathroom. The stay space may include a capsule hotel.

The stay space may include a mobile conference room. The mobile conference room may include a web conference system, a video conference system or a telephone conference system, and the like that are connectable to the network 40.

The stay space may include a booth that the user can use as a private room. The booth may be partitioned by an adjustable wall or blind, a roll curtain, or the like. The booth may be provided with soundproofing equipment, such as a noise canceller. The booth may be provided with equipment that allows the user to view and listen to content such as video or music.

The stay space is not limited to the above examples and may include various forms of spaces. When being used as the stay space, the vehicle 20 may include various types of equipment constituting the stay space that is configured to be detachable.

As described above, the operation management system 1 can increase the number of users using the second service, by providing various services as the second service. Consequently, the operation efficiency of the vehicles 20 is improved.

<Cooperation Between First Service and Second Service>

The server controller 12 may grant an incentive for when the first service is used to a user who has used the second service. For example, the server controller 12 may grant the right for preferential boarding over other users to the user who has used the second service. The server controller 12 may determine the operation schedule by prioritizing the desired condition of the user who has used the second service over the desired conditions of other users. The server controller 12 may grant the user who has used the second service the right to receive a discount on payment of a fare for use of the first service or the right to use the first service free of charge.

The server controller 12 may grant an incentive for when the second service is used to a user who has used the first service. For example, the server controller 12 may grant the user who has used the first service a coupon, such as a discount ticket or a free ticket, that is usable in a mobile shop provided as the second service. The server controller 12 may grant the user who has used the first service the right to receive a discount on a fee for use of a stay space provided as the second service or the right to use the stay space free of charge.

As described above, by establishing cooperation between the first service and the second service, the operation management system 1 encourages the user to use both the first service and the second service to thereby corral the user. Consequently, the operation efficiency of the vehicles 20 is improved.

While an embodiment of the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined together or divided.

1. An operation management apparatus comprising
a controller configured to manage operation of a vehicle, wherein
the controller is configured to:
cause the vehicle to provide a first service for transporting a user between at least two points during a first time period; and
cause the vehicle to provide a second service for enabling the user to stay at a predetermined point or in a predetermined area during a second time period.

2. The operation management apparatus according to claim 1, wherein
the controller is configured to:
acquire, from a terminal apparatus of the user, service application information applying for use of the first service or the second service; and
determine the first time period and the second time period based on the service application information.

3. The operation management apparatus according to claim 2, wherein
the controller is configured to calculate a shortage of vehicles that provide the first service in a predetermined time period based on the service application information and, when the shortage is greater than or equal to a predetermined number, set the predetermined time period as the first time period, and when the shortage is less than the predetermined number, set the predetermined time period as the second time period.

4. The operation management apparatus according to claim 1, wherein
the controller is configured to execute at least one of granting an incentive for when the first service is used to a user who has used the second service and granting an incentive for when the second service is used to a user who has used the first service.

5. The operation management apparatus according to claim 1, wherein
the controller is configured to cause the vehicle to travel along a predefined route in the second time period regardless of a designation by the user.

6. The operation management apparatus of claim 1, wherein
the second service includes at least one of provision of a product or a service at a mobile shop and provision of a stay space.

7. An operation management system comprising:
the operation management apparatus according to claim 1; and
the vehicle.

8. An operation management method for managing operation of a vehicle, the operation management method comprising:
causing the vehicle to provide a first service for transporting a user between at least two points during a first time period; and
causing the vehicle to provide a second service for enabling the user to stay at a predetermined point or in a predetermined area during a second time period.

9. The operation management method according to claim 8, further comprising:
acquiring, from a terminal apparatus of the user, service application information applying for use of the first service or the second service; and
determining the first time period and the second time period based on the service application information.

10. The operation management method according to claim 9, further comprising:
calculating a shortage of vehicles that provide the first service in a predetermined time period based on the service application information;
when the shortage is greater than or equal to a predetermined number, setting the predetermined time period as the first time period; and
when the shortage is less than the predetermined number, setting the predetermined time period as the second time period.

11. The operation management method according to claim 8, further comprising:
executing at least one of granting an incentive for when use the first service is used to a user who has used the second service and granting an incentive for when the second service is used to a user who has used the first service.

12. The operation management method according to claim 8, further comprising:
causing the vehicle to travel along a predefined route in the second time period regardless of a designation by the user.

13. The operation management method according to claim 8, further comprising:
executing, as the second service, at least one of provision of a product or a service at a mobile shop and provision of a stay space.

14. A vehicle configured to:
provide a first service for transporting a user between at least two points during a first time period; and
provide a second service for enabling the user to stay at a predetermined point or in a predetermined area during a second time period.

15. The vehicle according to claim 14, wherein the vehicle is configured to:
be changeable to either a first specification for providing the first service or a second specification for providing the second service; and
be changed to the first specification during the first time period and changed to the second specification during the second time period.

16. The vehicle according to claim 15, comprising
a stowable seat configured to be deployed in the first specification so as to allow the user to sit and to be stowed in the second specification.

17. The vehicle according to claim 14, wherein
equipment used to provide the second service is configured to be detachable.

18. The vehicle according to claim 14, wherein
the first time period corresponds to a time period in which a shortage of vehicles that provide the first service is greater than or equal to a predetermined number, and
the second time period corresponds to a time period in which the shortage of vehicles that provide the first service is less than the predetermined number.

19. The vehicle according to claim 14, wherein
the vehicle is configured to travel along a predefined route in the second time period regardless of a designation by the user.

20. The vehicle according to claim 14, wherein
the vehicle is configured to execute, as the second service, at least one of provision of a product or a service at a mobile shop and provision of a stay space.
